(19) United States
(12) Patent Application Publication
(10) Pub. No.: US 2005/0141730 A1
(43) Pub. Date: Jun. 30, 2005

(54) Vibration-based talk-through method and apparatus

(75) Inventor: Preston Vincent Murphy, Aura Park (SG)

Correspondence Address: Christine W Trebilcock;Cohen & Grigsby PC, 11 Stanwix Street, 15th Floor, Pittsburgh, PA, 15222, US

(73) Assignee: RTI Tech Pte Ltd., Singapore (SG)

(21) Appl. No.: 10/499,957

(22) PCT Filed: Dec. 21, 2001
(86) PCT No.: PCT/SG01/00259

(51) Int. Cl. H04R 1/10; H04R 25/00

(52) U.S. Cl. 381/74; 381/151

(57) ABSTRACT

Hearing protectors protect the ears of its user by providing high attenuation of surrounding noise. However, nearby warning signals and speech sounds are being attenuated together with the noise. Conventional muff-type talk-through hearing protectors uses a combination of external microphones, limiting amplifier, built-in speakers and muff-type hearing protectors to reduce the intensity of external noise to a safe level, allowing the user to hear external sounds. However, these headphone-type muffs impede its use together with other head-mounted protective equipment. Audio input from a bone vibrator to a user is carried by a combination of vibrations in the skull bones and inter-cranial fluids directly to the cochlea of the inner ear. Bone vibrators are inherently safe, as higher driving voltage also does not translate to a higher output. A bone vibrator is used in tandem with an amplified microphone and an in-ear-type hearing protection apparatus. Output from the primary amplified microphone can be attenuated when sound levels become excessive, allowing a user to continue hearing the surrounding conversations in the noise.

### FIELD OF INVENTION

The present invention relates generally to a talk-through system. In particular, the invention relates to a vibration-based talk-through apparatus.

### BACKGROUND

In a noise-filled environment, hearing protectors are used to protect the ears of its user. Earplugs, muff type circum-aural ear cups and the like hearing protectors, provide good hearing protection when properly worn. These hearing protectors provide high attenuation of surrounding noise. Active noise canceling devices further reduce the low frequency noise that the hearing protectors are unable to alleviate.

A hearing protector isolates its user from the environment in the acoustic domain. In environments where physical dangers are imminent, nearby voices, warning signals and sounds are being attenuated together with the noise. Ironically, the use of hearing protectors to protect the sense of hearing of its user may compromise the physical safety of the user in the process.

Various muff-type electronic hearing protectors use a combination of external microphones, limiting amplifiers and built-in speakers to introduce sound while controlling the intensity of external noise to a safe level. This allows the user to hear external sounds. These hearing protectors are conventionally known as active, electronic or talk-through hearing protectors because the user can hear speech through the hearing protectors.

However, these active hearing protectors require the use of headphone type muffs that impedes its use in conjunction with headgears, protective helmets, breathing apparatus and the like head-mounted gears. Moreover, these active hearing protectors cannot be used effectively with ear-plugs. This reduces the usefulness of these active hearing protectors for firefighters, construction workers and the like high noise environment operators or workers as the active hearing protectors cannot be used together with other respective head and respiratory protection equipment.

Since the speakers used in the active hearing protectors are capable of producing sound at a level in excess of 120 dB, limiting amplifiers are required to avoid transmitting hazardous sound levels to the ear. In the event of amplifier failure, this further exposes the ear to an inherently unsafe device, the speaker.

Hence, this clearly affirms a need for a better talk-through apparatus that addresses the foregoing problems.

### SUMMARY

Embodiments of the invention are based on the principle that audio input from a bone vibrator to a user is conducted by a combination of vibrations in the skull bones and inter-cranial fluids directly to the cochlea of the inner ear.

Conventional bone vibrators, which are also known as bone conduction transducers, are generally unable to transmit beyond 80-85 dB with reference to the sound pressure level of the inner ear. This places the output of bone vibrators within the “safe range” for continuous exposure of the ear to bone vibrator outputs. Attempts have been made to increase the output of a bone vibrator by increasing the driving voltage of the bone vibrator. However, the output of the bone vibrator becomes non-linear when a higher driving voltage is introduced. The higher driving voltage provided to the bone vibrator translates into vibrations that lift the bone vibrator off the skin of the user (i.e. similar to a jumping-effect). However, irritation from these high vibration levels are localised at the point where the bone vibrator comes into contact with the skin of the user. Hence, this shows that bone vibrators are inherently safe.

A bone vibrator is used in tandem with an amplified microphone and in-ear-type earplugs to provide a talk-through system. When deployed in an acoustic-hazardous environment, output from the amplified microphone can be attenuated when high sound levels lead to minor discomfort. This can be accomplished either by a conventional analogue compression amplifier or by a digital noise reduction element. This not only avoids distortion from the bone vibrator output, but also allows a user to continue hearing the surrounding conversations in the noise.

The talk-through system can be further coupled to a radio transmitter, a signal set, a receiver to function as a vibration-based communication system.

In accordance with a first aspect of the invention, there is disclosed a vibration-based talk-through apparatus for facilitating talk-through for a user using a hearing protection system, the vibration talk-through system comprising:
a microphone assembly, the microphone assembly comprising:
   a first microphone receiving ambient sounds from the surrounding environment; and
   a circuitry being electrically connected to the first microphone, the first microphone converting the ambient sounds received from the surrounding environment into ambient electrical signals, the circuitry amplifying the received ambient electrical signals and transmitting the amplified ambient electrical signals to the bone vibrator;
a bone vibrator disposable onto the skin covering a cranial bone of a user, the bone vibrator converting the amplified ambient electrical signals received from the circuitry into vibrations, the bone vibrator being coupled to the microphone assembly, the cranial bone conducting the vibrations to the cochlea of an inner ear of the user;
a hearing protection apparatus, the hearing protection apparatus being detachably coupled to the vibrator assembly, and the hearing protection apparatus substantially preventing sound from being transmitted to the inner ear of a user through the ear canal; and
a positioning means for mounting to an outer ear of the user the hearing protection apparatus in tandem with the positioning of the bone vibrator onto the cranial bone, and the hearing protection apparatus substantially preventing sound from being transmitted to the corresponding inner ear of the user through the ear canal,
wherein the bone vibrator is positionable onto the cranial bone in a manner that use of the hearing protection system is not substantially impeded.

In accordance with a second aspect of the invention, there is disclosed a method for providing vibration-based talk-through hearing protection, comprising the steps of:
disposing a hearing protection apparatus in relation to an outer ear of a user for substantially preventing sound from reaching the inner ear of a user through the outer ear;
receiving ambient sounds from the surrounding environment into a first microphone, the first microphone converting the ambient sounds received into ambient electrical signals;
amplifying the ambient electrical signals received from the first microphone, the ambient electrical signals being amplified by a circuitry, and the circuitry being electrically connected to the first microphone;
locating the bone vibrator onto the skin covering a cranial bone of the user, the cranial bone conducting the vibrations produced by the bone vibrator to the cochlea of the ear; and
transmitting the amplified ambient electrical signals to a bone vibrator, the bone vibrator converting the amplified ambient electrical signals into vibrations, the bone vibrator being electrically connected to the circuitry,
wherein the user is able to hear ambient sounds from the surrounding environment with the ear protected by the hearing protection apparatus.

### BRIEF DESCRIPTION OF THE DRAWINGS

Embodiments of the invention are described hereinafter with reference to the following drawings, in which:

FIG. 1 shows a perspective view of a vibration-based talk-through apparatus;

FIG. 2 shows a perspective view of the vibration-based talk-through apparatus FIG. 1 with a second microphone supported by a boom; and

FIG. 3 shows a perspective view of the vibration-based talk-through apparatus in FIG. 1 with a contact-based transducer attached to a cable.

### DETAILED DESCRIPTION

A vibration-based talk-through apparatus for addressing the foregoing problems is described hereinafter.

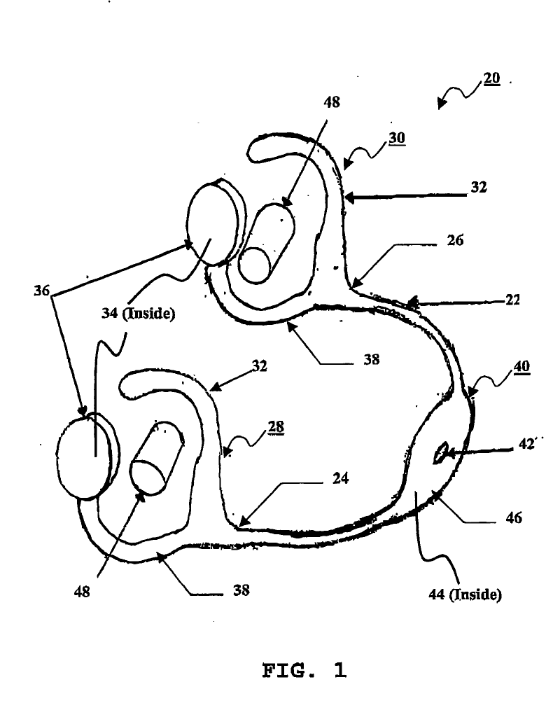

A first embodiment of the invention, a vibration-based talk-through apparatus 20 as shown in FIG. 1; includes a C-shaped headband 22 for extending around the neck of a user. The headband 22 has a first end 24 and an opposed second end 26. The headband 22 is resiliently biased for fitting heads of various girths.

A first ear-hook assembly 28 and second ear-hook assembly 30 is coupled to the first end 24 and second end 26 of the headband 22 respectively. Each ear-hook assembly 28/30 includes an ear-hook 32, a bone vibrator 34 (not shown) placed inside a vibrator housing 36 and a holder 38. The ear-hook 32 is substantially shaped and dimensioned to conform to the outer periphery of an ear of a user. The ear-hook 32 extends over the superior periphery of the ear of the user. The bone vibrator 34 is positioned above the temporal bone. The bone vibrator 34 converts any received electrical signals into vibrations. The temporal bone conducts vibrations generated by the bone vibrator 34 and transmits the vibrations to the ear of the user.

The vibrator housing 36 is shaped and dimensioned to accommodate the bone vibrator 34 within. The holder 38 extends from the ear-hook 32 to the vibrator housing 36.

The holder 38 extends along a portion of the inferior periphery of the ear of the user. The holder 38 positions the bone vibrator 34 onto the temporal bone. The ear-hook 32 permits easy removal of the vibration-based talk-through apparatus 20 from the head of the user. This also facilitates the easy wearing of the vibration-based talk-through apparatus 20 onto the head of the user as the ear-hook assembly 28/30 acts to locates the bone vibrator 34 onto the temporal bone and holds the bone vibrator 34 firmly in place. The first microphone 42 is preferably located far from the mouth of the user for substantially reducing speech sounds from being picked up by the first microphone 42.

A microphone assembly 40 is detachably coupled to the headband 22 and includes a first microphone 42, a circuitry 44 (not shown) and a microphone housing 46. The first microphone 42 receives ambient sounds from the surrounding environment. The first microphone 42 is electrically connected to the circuitry 44. The first microphone 42 converts ambient sounds received into ambient electrical signals. The ambient electrical signals are then transmitted to the circuitry 44. The circuitry 44 amplifies the received ambient electrical signals and transmits the amplified ambient electrical signals to the bone vibrator 34. The microphone housing 46 is shaped and dimensioned to house both the first microphone 42 and the circuitry 44. The microphone housing 46 is coupled to the headband 22. The bone vibrator 34 is electrically connected to the circuitry 44.

The circuitry 44 is an active circuitry which has a frequency response of preferably from 400 Hz to 4 kHz. A battery supplies power to the circuitry 44. The microphone housing 46 is further shaped and dimensioned to house the battery.

The circuitry 44 includea compression amplifier (not shown) for scaling the level of ambient electrical signals below a pre-determined level for transmission to the bone vibrator 34. The scaling of the level of ambient electrical signals substantially reduces distortion at the bone vibrator 34 when a high level of ambient sound is received by the first microphone 42.

The circuitry 44 includes a noise reduction element (not shown) having a limiting level which is pre-determined. The noise reduction element passing ambient electrical signals having levels not exceeding the limiting level to the circuitry 44 for amplification, and rejecting ambient electrical signals having levels exceeding the limiting level.

The first embodiment of the invention, the vibration-based talk-through apparatus 20, is used in tandem with a hearing protection apparatus 48. The bearing protection apparatus 48 is preferably an in-ear-type apparatus that functions to impede sound from being transmitted to the inner ear of the user through the ear canal and therefore provides hearing protection. However, the hearing protection apparatus 48 can also be either a super-aural or a circum-aural (i.e. muff-type) hearing protection apparatus. The vibration-based talk-through apparatus 20 allows speech, warning signals and ambient sounds in the frequency range of 400 Hz to 4000 kHz to be transmitted to the user.

The ear-hook 32 is shaped allow access to the outer ear. This allows the hearing protection apparatus 48 to be easily inserted into or removed from the ear canal without removing the vibration-based talk-through apparatus 20 from the head of the user. Preferably, the hearing protection apparatus 48 is detachably coupled to the vibrator assembly 36 using lengths of strings. The stings prevent the misplacing of the hearing protection apparatus 48 when it is removed from the ear of the user.

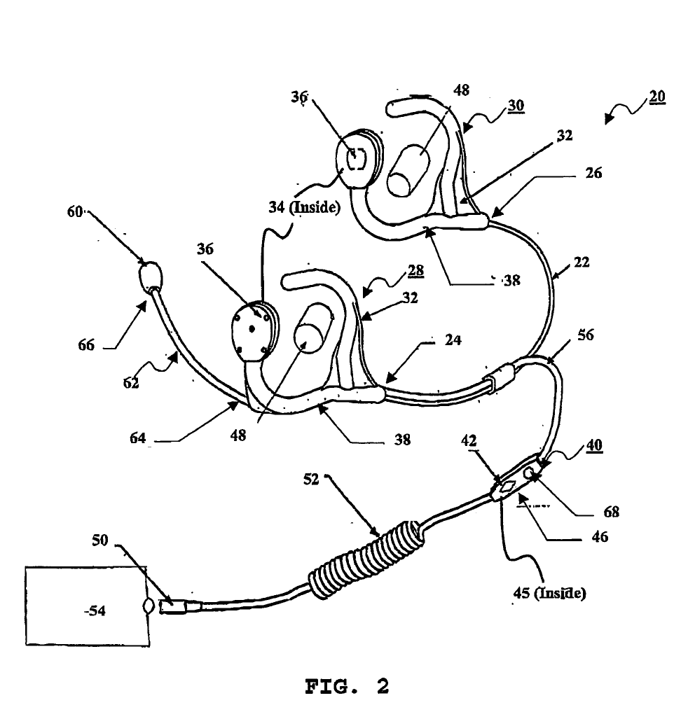

A second embodiment of the invention, a vibration-based talk-through apparatus 20 as seen in FIG. 2, comprises of eight main elements: a headband 22, a first ear-hook assembly 28, a second ear-hook assembly 30, a bone vibrator 34, a vibrator housing 36, a microphone assembly 40, a first microphone 42 and a hearing protection apparatus 48. The descriptions in relation to the structural configurations of and positional relationships among the components described in the first embodiment of the invention with reference to FIG. 1 are incorporated herein. The microphone assembly 40 and the headband 22 are interconnected by a short length of wire.

An I/O (input/output) adapter 50 is electrically connected to the circuitry 44. An extendible cable 52 extends from the microphone assembly 40 to the I/O adapter 50. The I/O adapter 50 is coupled to a transceiver 54. The transceiver 54 transmits and receives electrical signals via radio waves for facilitating radio communications with a base station.

The transceiver 54 converts first speech electrical signals received from the circuitry 45 into radio waves for transmission. The transceiver 54 also receives radio waves and converts into second speech electrical signals for transmission to the circuitry 45. By doing so, the transceiver 54 facilitates radio communications between the user of the vibration-based communication systems and users of other communication systems.

The circuitry 45 mixes ambient electrical signals received from the first microphone 42 with second speech electrical signals received from the transceiver 54. The circuitry 44 amplifies the mixed electrical signals and transmits the amplified electrical signals to the bone vibrator 34.

However, it is preferred that the circuitry 45 prevents ambient electrical signals received from the first microphone 42 from being transmitted to the bone vibrator 34 when second speech electrical signals are received from the transceiver 54 by performing switching operations. The circuitry 45 amplifies the second speech electrical signals received from the transceiver 54 and transmits the amplified second speech electrical signals to the bone vibrator 34.

Alternatively, the circuitry 45 prevents second speech electrical signals received from the transceiver 54 from being transmitted to the bone vibrator 34 when ambient electrical signals are received from the first microphone 42 by performing switching operations. The circuitry 45 amplifies the ambient electrical signals received from the first microphone 42 and transmits the amplified ambient electrical signals to the bone vibrator 34.

A primary cable 56 extends from the microphone assembly 40 to the first ear-hook assembly 28. The primary cable 56 provides dexterity to the microphone assembly 40. The first microphone 42 remains electrically connected to the circuitry 4S.

A second microphone 58 (not shown) is electrically connected to the circuitry 45. The second microphone 58 converts articulated sounds received from the user into first speech electrical signals by being positioned near the mouth of the user. These first speech electrical signals are then transmitted to the circuitry 45. A microphone windscreen 60 is shaped and dimensioned to cover the second microphone 58. A boom 62 has a first end 64 that is coupled to either first or second ear-hook assembly 28/30 and an opposing second end 66 that is coupled to the second microphone 58. The second end 66 of the boom 62 is adjustable for positioning the second microphone 5S in front of the mouth. The second microphone 58 is preferably a noise cancelling microphone for cancelling noise and ambient sounds.

A switch 68, preferably a PTT (push-to-talk) switch, has two states: an ACTIVATED state and an INACTIVATED state. The switch 68 is coupled to the circuitry 45. In the ACTIVATED state, the circuitry 44 amplifies the first speech electrical signals received from the second microphone 58 and transmits the amplified first speech electrical signals to the transceiver 54. In the INACTIVATED state, the circuitry 44 prevents the transmission of first speech electrical signals received from the second microphone 58 to the transceiver 54.

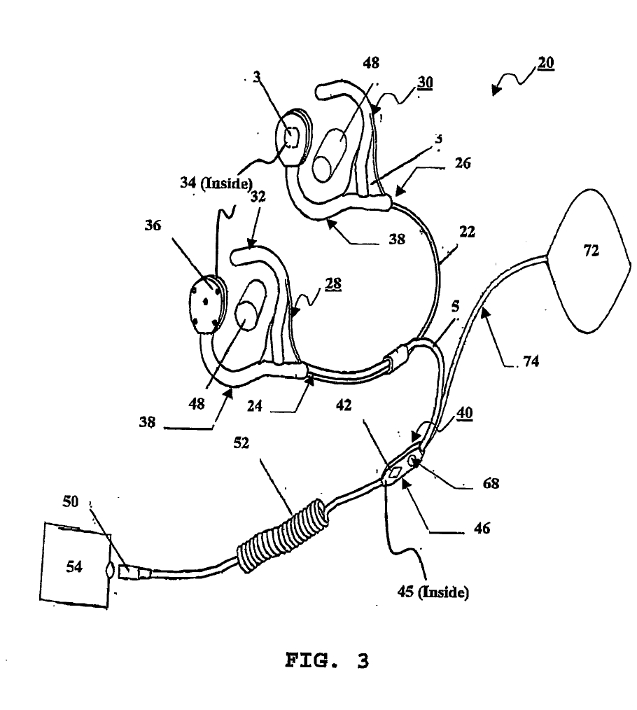

A third embodiment of the invention, a vibration-based talk-through apparatus 20 as seen in FIG. 3, comprises of nine main elements: a headband 22, a first ear-hook assembly 28, a second ear-hook assembly 30, a bone vibrator 34, a microphone assembly 40, a first microphone 42, a hearing protection apparatus 48 an I/O adapter 50, and a transceiver 54. The descriptions in relation to the structural configurations of and positional relationships among the components described in the second embodiment of the invention with reference to FIG. 2 are incorporated herein, with the exception that three elements: a second microphone 58, a microphone windscreen 60, and a boom 62, which are correspondingly replaced by a contact-based transducer 70 (not shown), a transducer housing 72 and a secondary cable 74 in the third embodiment. These replacements are preferable in situations where a breathing apparatus is used.

The contact-based transducer 70 is electrically connected to the circuitry 45. The contact-based transducer 70 converts vibrations received from the skull of a user into first speech electrical signals. These first speech electrical signals are transmitted from the contact-based transducer to the circuitry 45. The transducer housing 72 is shaped and dimensioned to house the contact-based transducer 70. The transducer housing 72 is preferably flexible to allow it to conform to the outer periphery of the posterior region of a human skull and allow for attachment thereto. The secondary cable 74 extends from the transducer housing 72 to the microphone assembly 40. The secondary cable 74 has substantial length and flexibility to allow the contact-based transducer 70 to be placed anywhere on the skull of a human. The contact-based transducer 70 does not pick up ambient sounds and speech.

A switch 68, preferably a PTT (push-to-talk) switch, has two states: an ACTIVATED state and an INACTIVATED state. The switch 68 is coupled to the circuitry 45. In the ACTIVATED state, the circuitry 45 amplifies the first speech electrical signals received from the contact-based transducer 70 and transmits the amplified first speech electrical signals to the transceiver 54. In the INACTIVATED state, the circuitry 45 prevents the transmission of first speech electrical signal signals received from the contact-based transducer 70 to the transceiver 54.

The sealed construction of the first ear-hook assembly 28, the second ear-hook assembly 30 and the microphone assembly allows the first, second and third embodiments of the invention, the vibration-based talc-through apparatus 20 to be water-resistant to a certain depth.

In the foregoing manner, a vibration-based talk-through apparatus is described according to three embodiments of the invention for addressing the foregoing disadvantages of conventional vibration-based talk-through apparatus. Although only three embodiments of the invention are disclosed, it is apparent to one skilled in the art in view of this disclosure that numerous changes and/or modification can be made without departing from the scope and spirit of the invention.

1. A vibration-based talk-through apparatus for facilitating talk-through for a user using a hearing protection apparatus, the vibration talk-through system comprising:
a microphone assembly, the microphone assembly comprising:
a first microphone for receiving ambient sounds from the surrounding environment, and
a circuitry being electrically connected to the first microphone, the first microphone converting the ambient sounds received from the surrounding environment into ambient electrical signals,
a bone vibrator disposable onto the skin covering a cranial bone of a user, the circuitry amplifying the received ambient electrical signals and transmitting the amplified ambient electrical signals to the bone vibrator, the bone vibrator converting the amplified ambient electrical signals received from the circuitry into vibrations, the bone vibrator being coupled to the microphone assembly, the cranial bone conducting the vibrations to the cochlea of an inner ear of the user,
a hearing protection apparatus for substantially preventing sound from being transmitted to the inner ear of a user tough the ear canal; and
a positioning means for enabling mounting to an outer ear of the user the hearing protection apparatus in tandem with the positioning of the bone vibrator onto the cranial bone, and the hearing protection apparatus being detachably coupled to the positioning means and for substantially preventing sound from being transmitted to the corresponding inner ear of the user through the ear canal,
wherein the bone vibrator is positionable onto the cranial bone in a manner that use of the hearing protection apparatus is not substantially impeded.

2. The vibration-based talk-through apparatus as in claim 1, wherein the hearing protection apparatus is one of in-ear, super-aural or circum-aural hearing protection apparatus.

3. The vibration-based talk-through apparatus as in claim 1, wherein the circuitry includes a compression amplifier for scaling the level of ambient electrical signals below a pre-determined level for transmission to the bone vibrator, and the scaling of the level of ambient electrical signals substantially reducing distortion at the bone vibrator when a high level of ambient sound is received by the first microphone.

4. The vibration-based talk-through apparatus as in claim 1, wherein the circuitry includes a noise reduction element having a limiting level, the limiting level being pre-determined, the noise reduction element passing speech electrical signals and ambient electrical signals having levels below the limiting level.

5. The vibration-based talk-through apparatus as in claim 1, wherein the cranial bone is the temporal bone, the temporal bone conducting vibrations from the bone vibrator.

6. The vibration-based talk-through apparatus as in claim 1, wherein the cranial bone is the squamous part of the temporal bone, the squamous part of the temporal bone conducting vibrations from the bone vibrator.

7. The vibration-based talk-through apparatus as in claim 1, wherein the positioning means is substantially shaped and dimensioned to conform to the outer periphery of an ear of the user.

8. The vibration-based talk-through apparatus as in claim 7, further comprising a holder extending from the positioning means to the bone vibrator, the holder supporting the bone vibrator and firmly biasing the bone vibrator onto the cranial bone.

9. The vibration-based talk-through apparatus as in claim 8, further comprising:
a harness extendible around the neck of a user, the harness having opposing first and second ends,
wherein an attachment assembly is attached to each end of the harness, the attachment assembly including the bone vibrator, the positioning means and the holder.

10. The vibration-based talk-through apparatus as in claim 9, wherein the harness is resiliently biased for fitting heads of various girths.

11. The vibration-based talk-through apparatus as in claim 9, wherein the circuitry has a frequency response of between 300 Hz to 4000 kHz.

12. The vibration-based talk-through apparatus as in claim 9, further comprising a battery supplying power to the circuitry, the circuitry being an active-type.

13. The vibration-based talk-through apparatus as in claim 12, further comprising:
a second microphone electrically connected to the circuitry for receiving articulated sounds from the user, the second microphone converting articulated sounds received from the user into first speech electrical signals and providing the first speech electrical signals to the circuitry;
an input/output (I/O) adapter electrically connected to the circuitry;
a transceiver, the I/O adapter being coupled to the transceiver, the transceiver converting first speech electrical signals received from the circuitry into radio waves for transmission, the transceiver also receiving radio waves and converting into second speech electrical signals for transmission to the circuitry.

14. The vibration-based talk-through apparatus as in claim 13, wherein the circuitry mixes ambient electrical signals received from the first microphone with second speech electrical signals received from the transceiver, the circuitry amplifying the mixed electrical signals and transmitting the amplified electrical signals to the bone vibrator.

15. The vibration-based talk-through apparatus as in claim 13, wherein the circuitry prevents ambient electrical signals received from the first microphone from being transmitted to the bone vibrator when second speech electrical signals are received from the transceiver by performing switching operations, the circuitry amplifying the second speech electrical signals received from the transceiver and transmitting the amplified second speech electrical signals to the bone vibrator.

16. The vibration-based talk-through apparatus as in claim 13, wherein the circuitry prevents second speech electrical signals received from the transceiver from being transmitted to the bone vibrator when ambient electrical signals are received from the first microphone by performing switching operations, the circuitry amplifying the ambient electrical signals received from the transceiver and transmitting the amplified ambient electrical signals to the bone vibrator.

17. The vibration-based talk-through apparatus as in claim 13, further comprising a switch coupled to the circuitry, the switch comprising:
an ACTIVATED state permitting the circuitry to amplify the first speech electrical signals received from the second microphone and transmitting the amplified first speech electrical signals to the transceiver; and
an INACTIVATED state wherein the circuitry prevents the transmission of first speech electrical signals received from the second microphone to the transceiver.

18. The vibration-based talk-through apparatus as in claim 13, wherein the second microphone constitutes an element of a contact-based transducer electrically connected to the circuitry and being positionable onto the skull of a user, the contact-based transducer for converting vibrations received from the skull of the user produced by articulated sounds from the user into first speech electrical signals and providing the first speech electrical signals to the circuitry.

19. The vibration-based talk-through apparatus as in claim 18, further comprising a switch coupled to the circuitry, the switch comprising:
an ACTIVATED state permitting the circuitry to amplify the first speech electrical signals received from the contact-based transducer and transmitting the amplified first speech electrical signals to the transceiver; and
an INACTIVATED state wherein the circuitry prevents the transmission of first speech electrical signals received from the contact-based transducer to the transceiver.

20. The vibration-based talk-through apparatus as in claim 13, wherein the second microphone constitutes an element of a contact-based transducer electrically connected to the circuitry and being positionable into the ear of a user, the contact-based transducer for converting vibrations received from the ear of the user produced by articulated sounds from the user into first speech electrical signals and providing the first speech electrical signals to the circuitry.

21. The vibration-based talk-through apparatus as in claim 20, further comprising a switch coupled to the circuitry, the switch comprising:
an ACTIVATED state permitting the circuitry to amplify the first speech electrical signals received from the contact-based transducer and transmitting the amplified first speech electrical signals to the transceiver, and
an INACTIVATED state wherein the circuitry prevents the transmission of first speech electrical signals received from the contact-based transducer to the transceiver.

22. A method for providing vibration-based talk-through hearing protection using a vibration-based talk-through apparatus, comprising the steps of:
disposing a hearing protection apparatus in relation to an outer ear of a user for substantially preventing sound from reaching the inner ear of a user through the outer ear;
receiving ambient sounds from the surrounding environment into a first microphone, the first microphone converting the ambient sounds received into ambient electrical signals;
amplifying the ambient electrical signals received from the first microphone, the ambient electrical signals being amplified by a circuitry, and the circuitry being electrically connected to the first microphone;
locating a bone vibrator onto the skin covering a cranial bone of the user, the cranial bone conducting the vibrations produced by the bone vibrator to the cochlea of the ear; and
transmitting the amplified ambient electrical signals to the bone vibrator, the bone vibrator converting the amplified ambient electrical signals into vibrations, the bone vibrator being electrically connected to the circuitry,
wherein the user is able to hear ambient sounds from the surrounding environment with the ear protected by the hearing protection apparatus, and the hearing protection apparatus, the first microphone, the circuitry and the bone vibrator being constituents of the vibration-based talk-through apparatus.

23. The method for providing vibration-based talk-through hearing protection as in claim 22, wherein the circuitry includes a compression amplifier for scaling the level of ambient electrical signals below a predetermined level for transmission to the bone, vibrator, and the scaling of the level of ambient electrical signals substantially reducing distortion at the bone vibrator when a high level of ambient sound is received by the first microphone.

24. The method for providing vibration-based talk-through hearing protection as in claim 22, wherein the circuitry includes a noise reduction element having a limiting level, the limiting level being pre-determined, the noise reduction element passing speech electrical signals and ambient electrical signals having levels below the limiting level.

25. The method for providing vibration-based talk-through hearing protection as in claim 22, further comprising the step of using the vibration-based talk-through apparatus for remote communication via wireless channel.

26. The method for providing vibration-based talk-through hearing protection as in claim 25, further comprising the steps of:
receiving articulated sounds from the user into a second microphone positional proximal to the mouth of the user, the second microphone converting the received articulated sounds into first speech electrical signals;
amplifying the first speech electrical signals received from the second microphone, the first speech electrical signals being amplified by the circuitry, and the circuitry being electrically connected to the second microphone;
transmitting the amplified first speech electrical signals to a transceiver, the transceiver converting first speech electrical signals received from the circuitry into radio waves for transmission, the transceiver also receiving radio waves and converting into second speech electrical signals for transmission to the circuitry;
amplifying the second speech electrical signals received from the transceiver, the second speech electrical signals being amplified by the circuitry; and
transmitting the amplified second speech electrical signals to a bone vibrator, the bone vibrator converting the amplified second speech electrical signals into vibrations,
wherein the transceiver facilitates remote communication.

27. The method for providing vibration-based talk-through hearing protection as in claim 25, further comprising the steps of:
receiving vibrations from the skull of a user into a contact-based transducer positionable onto the skull of the user, the vibrations being produced by articulated sounds from the user and the contact-based transducer converting the received vibrations into first speech electrical signals;
amplifying the first speech electrical signals received from the contact-based transducer, the first speech electrical signals being amplified by the circuitry, and the circuitry being electrically connected to the contact-based transducer;
transmitting the amplified first speech electrical signals to a transceiver, the transceiver converting first speech electrical signals received from the circuitry into radio waves for transmission, the transceiver also receiving radio waves and converting into second speech electrical signals for transmission to the circuitry;
amplifying the second speech electrical signals received from the transceiver, the second speech electrical signals being amplified by the circuitry; and
transmitting the amplified second speech electrical signals to a bone vibrator, the bone vibrator converting the amplified second speech electrical signals into vibrations,
wherein the transceiver facilitates remote communication.
